(19) United States
(12) Patent Application Publication
(10) Pub. No.: US 2009/0180275 A1
(43) Pub. Date: Jul. 16, 2009

(54) LAMP UNIT, EDGE LIGHT TYPE BACKLIGHT MODULE AND LIQUID CRYSTAL DISPLAY DEVICE

(75) Inventor: Kenji ARITA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/343,717

(22) Filed: Dec. 24, 2008

(30) Foreign Application Priority Data
Jan. 11, 2008 (JP) 2008-004093

(51) Int. Cl. G02F 1/13357; F21V 15/01; G09F 13/08

(52) U.S. Cl. 362/97.2; 362/217.12; 362/97.1

(57) ABSTRACT

A lamp unit includes a linear illuminant having external electrodes at both ends; a housing case for housing the linear illuminant; a pair of holding members fitted in both ends of the housing case; and conductive connection terminals locked to each of the pair of holding members, respectively, wherein each of the connection terminals includes a gripper for gripping each of the external electrodes of the linear illuminant, and each of the external electrodes of the linear illuminant is electrically connected to each of the connection terminals by each gripper.

### BACKGROUND OF THE INVENTION

1. Field of the Invention

The present invention relates to a technique of a backlight for a liquid crystal display device.

2. Description of the Background Art

A conventional liquid crystal display device is provided with a backlight unit (also referred to as a “backlight module”) for illuminating a liquid crystal display panel. A backlight unit employs an edge light (side light) type or a direct light type in accordance with arrangement of a backlight (lamp unit). A direct light type backlight (direct back light) unit has a backlight provided at a backside of the liquid crystal display panel with a diffusion plate interposed therein. On the other hand, an edge light type (edge back light) backlight unit has a backlight arranged at a side edge of the liquid crystal display panel, and a light emitted therefrom is conducted to a light guide plate placed at the backside of the liquid crystal display panel.

For example, there is a liquid crystal display device adopting a structure of mounting a lamp unit by inserting and extracting in the edge light type backlight unit (for example, see Japanese Patent Application Laid-Open No. 2001-281658).

A lamp unit used for such a liquid crystal display device with a mounting structure by inserting and extracting generally employs a cold cathode fluorescent lamp (CCFL) as an illuminant (light source).

However, an electrode of a cold cathode fluorescent lamp in the above-described lamp unit is connected to a lamp cable by soldering so that it is difficult to replace only a lamp when the lamp goes out, causing the wasted cost by replacing the whole lamp unit when the lamp goes out.

### SUMMARY OF THE INVENTION

An object of the invention is to provide techniques allowing easy replacement of only a lamp.

In order to attain the object, according to a first aspect of the invention, a lamp unit includes: a linear illuminant having external electrodes at both ends; a housing case for housing the linear illuminant; a pair of holding members fitted in both ends of the housing case; and conductive connection terminals locked to each of the pair of holding members, respectively. Each of the connection terminals includes a gripper for gripping each of the external electrodes of the linear illuminant, and each of the external electrodes of the linear illuminant is electrically connected to each of the connection terminals by each gripper.

The external electrodes of the linear illuminant are configured to be electrically connected to the connection terminals by being gripped with each gripper of the connection terminals, thereby allowing easy replacement of the linear illuminant.

Furthermore, in order to attain the object, according to a second aspect of the invention, a lamp unit includes: a linear illuminant having external electrodes at both ends; a housing case for housing the linear illuminant; holding members for holding the linear illuminant in the housing case; and conductive connection terminals locked to the holding members. The housing case and the holding member are integrally formed, and each of the connection terminals includes a gripper for gripping each of the external electrodes of the linear illuminant. Each of the external electrodes of the linear illuminant is electrically connected to each of the connection terminals by each gripper of the connection terminals.

The external electrodes of the linear illuminant are configured to be electrically connected to the connection terminals by being gripped with each gripper of the connection terminals, thereby allowing easy replacement of the linear illuminant.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view for showing an exterior structure of a backlight unit and a lamp unit in a liquid crystal display device according to a first preferred embodiment of the invention.

FIG. 2 is an exploded perspective view of the lamp unit.

FIG. 3 is a view for showing a holding member and a connection terminal at an anode side.

FIG. 4 is a view for showing the anode side connection terminal fitted in the anode side holding member.

FIG. 5 is view for showing a holding member and a connection terminal at a cathode side.

FIG. 6 is a view for showing the cathode side connection terminal fitted in the cathode side holding member.

FIG. 7 is a view for showing a main body of the lamp unit and a cable assembly.

FIG. 8 is an enlarged view of an area surrounded by the broken line in FIG. 7.

FIG. 9 is an enlarged view of an area surrounded by the broken line in FIG. 7 taken from the left.

FIG. 10 is an exploded perspective view of the lamp unit according to a second preferred embodiment of the invention.

### DESCRIPTION OF THE PREFERRED EMBODIMENTS

Preferred embodiments of the invention are described below with reference to the drawings.

### First Preferred Embodiment

<Overall Configuration>

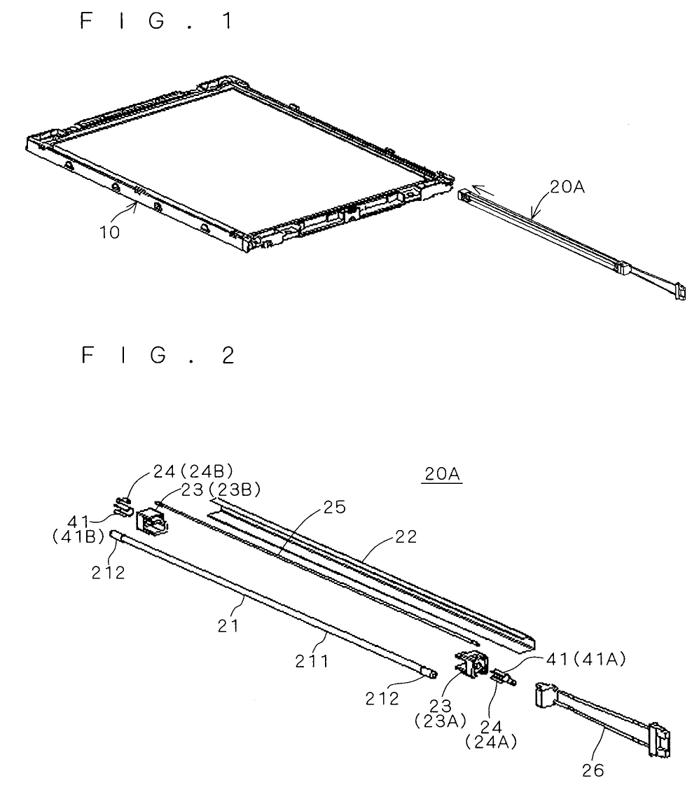

FIG. 1 is a view for showing an exterior structure of a backlight unit 10 and a lamp unit 20A in a liquid crystal display device according to a first preferred embodiment of the invention. FIG. 2 is an exploded perspective view of the lamp unit 20A.

As shown in FIG. 1, the lamp unit 20A is configured to be capable of being inserted or extracted (inserted or released) to/from an edge light type backlight unit (also referred to as an “edge light type backlight module”) 10, and configured as a lighting device for illuminating light on a liquid crystal display panel (not shown) with a state of being mounted on the backlight unit 10.

As shown in FIG. 2, the lamp unit 20A includes a long (linear) illuminant (also referred to as a “linear illuminant”) 21, a case (also referred to as a “housing case”) 22 for housing the linear illuminant 21, holding members 23, connection terminals 24, a connection cable 25 and a cable assembly 26.

The linear illuminant 21 is formed of, for example, an external electrode fluorescent lamp (EEFL), and includes electrodes (also referred to as “external electrodes”) 212 having a substantially same radius as a light emitting part 211 at both ends of the light emitting part 211.

The housing case 22 is a long housing capable of housing the linear illuminant 21, and a long opening is provided at one side of the housing. With a state in which the lamp unit 20A is mounted on the backlight unit 10, emitted light from the linear illuminant 21 is illuminated toward a light guide plate (not shown) in the backlight unit 10 through the long opening.

Furthermore, the housing case 22 is formed of, for example, metallic material, and an interior surface (inner wall surface) in which the linear illuminant 21 is housed is administered a mirror-like finishing. Thereby, light illuminated into the interior surface of the housing case 22 out of emitted light of the linear illuminant 21 is reflected in the interior surface, illuminating the light guide plate. The housing case 22 has a function to reflect light illuminated into its interior surface as described in the above, thus expressed also as a reflector case.

The holding members 23 are formed of insulating material with high reflection efficiency (white-related color nylon resin, for example), fitted and fixed to both ends of the housing case 22. More specifically, an anode side holding member 23A is fitted into the housing case 22 at an anode side of the linear illuminant 21, and a cathode side holding member 23B is fitted into the housing case 22 at a cathode side of the linear illuminant 21. The holding members 23 have a function to hold the linear illuminant 21 in the housing case 22, cooperating with connection terminals 24 described next. Details will be described below.

The connection terminals 24 are formed of elastic deformable conductive material (tinned brass, for example). The connection terminals 24 are fitted in the holding members 23 and locked thereto. The connection terminals 24 fitted in the holding members 23 are electrically connected to the electrodes of the linear illuminant 21.

More specifically, the connection terminals 24 include grippers 41 having substantially C-shaped cross sections, and the grippers 41 hold the electrodes 212 of the linear illuminant 21 by elastic force. Thereby, the connection terminals 24 and the linear illuminant 21 are electrically connected with each other. It is noted that the connection terminals 24 are consisted of an anode side connection terminal 24A corresponding to the anode side holding member 23A and a cathode side connection terminal 24B corresponding to the cathode side holding member 23B. Details will be described below.

The connection cable 25 includes joining terminals at both ends, which can be fitted in a connector 35CA (see FIG. 4) provided in the anode side holding member 23A and a connector 34CB (see FIG. 6) provided in the cathode side holding member 23B, respectively. It is noted that the connection cable 25 in FIG. 2 employs bullet terminals, but may employ flat type joining terminals as well.

The cable assembly 26 is configured to be put on and off from the anode side holding member 23A, and is able to supply external power with being put on the anode side holding member 23A. Details will be described below.

<Holding Members and Connection Terminals>

Details of the holding members 23 and the connection terminals 24 will be described below.

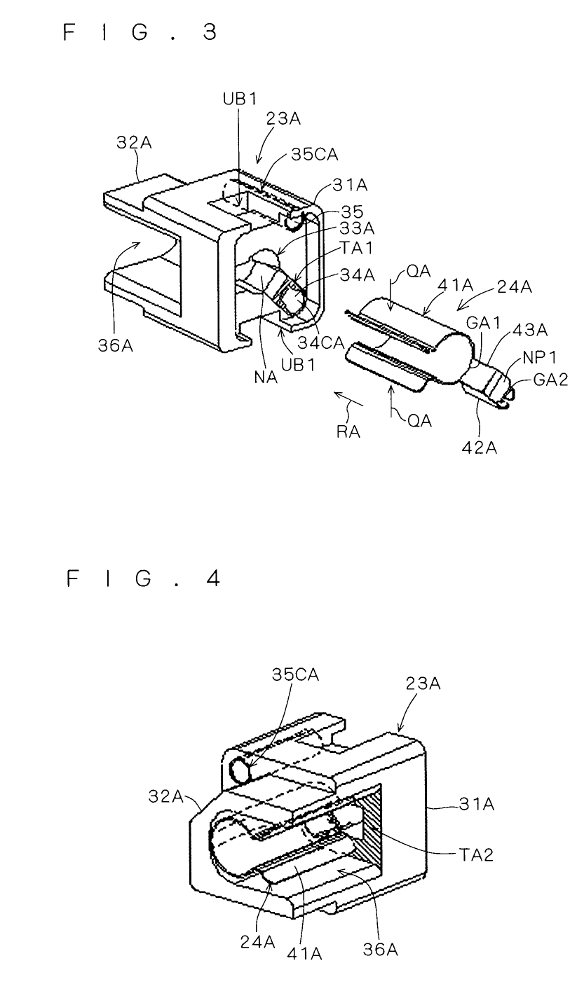

First, the anode side holding member 23A and the anode side connection terminal 24A are described referring to FIG. 3 and FIG. 4. FIG. 3 is a view for showing the anode side holding member 23A and the anode side connection terminal 24A. FIG. 4 is a view for showing the anode side connection terminal 24A fitted in the anode side holding member 23A.

As shown in FIG. 3, the anode side holding member 23A includes a substantially cubical main part 31A and a connection part 32A fitted into the housing case 22.

A hollow area 33A is formed in the main part 31A of the anode side holding member 23A, penetrating from one main surface of the main part 31A to the other main surface (a facing surface) facing the main surface. The hollow area 33A includes a region (also referred to as a “narrowed portion”) NA of which opening size is narrower in the main surface side than the facing surface side. Further, a part of the anode side connection terminal 24A (to be exact, a gripper 41A) is inserted into the hollow area 33A (described later). When the hollow area 33A is seen in the whole view of the lamp unit 20A (see FIG. 2), it may be expressed that the hollow area 33A would penetrate in an extended direction of the linear illuminant 21.

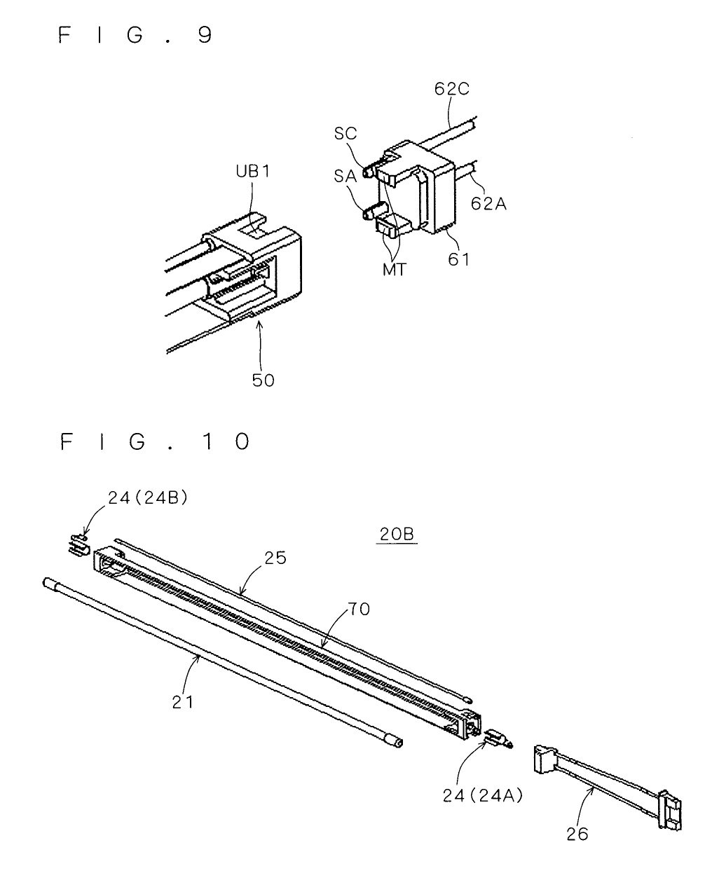

Moreover, two substantially circular openings 34A and 35 are formed in the above-described main surface of the main part 31A. A part of the anode side connection terminal 24A (to be exact, a cylindrical terminal 42A) is inserted into the opening 34A. A through hole penetrating to the facing surface side is formed in the other opening 35. A cylindrical connection terminal having conductivity is mounted in the through hole. Thereby, the through hole is configured as a connector 35CA for allowing a joint terminal of the connection cable 25 and an anode side joint terminal SA (see FIG. 9) of the cable assembly 26 to be fitted from the facing surface side and the main surface side, respectively.

A concave portion UB1 which assists the mounting of the cable assembly 26 is formed in the main part 3 1A from the main surface to a side surface. The concave portion UB1 is formed so as to make connection fixed nails MT (see FIG. 9) of the cable assembly 26 fit therein. Thus the cable assembly 26 is put on by fitting the connection fixed nails MT into the concave portion UB1.

Meanwhile, the connection part 32A leading to the housing case 22 is provided at the above-described facing surface side of the main part 31A. The connection part 32A is formed along a shape of cross section of a casing of the housing case 22 to be fitted into one end of the casing. An opening (also referred to as an “electrode removable opening”) 36A for attaching and removing electrodes linked to the hollow area 33A is formed in a surface of the connection part 32A corresponding to an opening side of the casing.

The anode side connection terminal 24A includes a substantially tubular gripper 41A (41) formed by curving a plate member to form a substantially C-shaped cross section, a cylindrical terminal (also referred to as a “tube terminal”) 42A having a slit, and a connection piece 43A having a substantially L-shaped cross section. The gripper 41A and the tube terminal 42A are electrically connected with each other through the connection piece 43A.

More specifically, the anode side connection terminal 24A is configured by joining each edge portion of the substantially tubular gripper 41A and the tube terminal 42A with the connection piece 43A, the each edge portion being closest to each other in the edge portions defining each side surface of the tubular gripper 41A and the tube terminal 42A, with a state in which the tubular gripper 41A and the tube terminal 42A are placed to make their central axes substantially parallel to each other. Also, the gripper 41A, the connection piece 43A and the tube terminal 42A may be integrally formed by a mold.

As shown in FIG. 3, the connection piece 43A is formed by bending a rectangular plate member into L-shape. A lateral edge GA1 at one edge side in a short side direction of the rectangular plate member is connected to an edge of the gripper 41A formed in C-shape, and a lateral edge GA2 at the other edge side in a short side direction of the rectangular plate member is connected to an edge of the tube terminal 42A.

The anode side connection terminal 24A configured as the above is fitted into the main part 31A from the main surface of the main part 31A.

When fitting the anode side connection terminal 24A into the anode side holding member 23A, an opening of the narrowed portion NA in the hollow area 33A is formed smaller than a cross section of the gripper 41A at an edge of insertion side so that the gripper 41A is inserted from a direction (insertion direction) shown by an arrow RA with being pressed from a direction shown by an arrow QA.

After the gripper 41A passes through the narrowed potion NA, the gripper 41A elastically deformed returns to its initial form. Thereby, when the gripper 41A is going to move to the opposite direction as the insertion direction after passing through the narrowed portion NA, a side surface of the gripper 41A is going to hit (strike) a hatching part TA2 shown in FIG. 4. Therefore, the gripper 41A cannot pass through the narrowed portion NA once again due to interference between the gripper 41A returned to its initial form and the hatching part TA2.

When the gripper 41A further moves into the insertion direction, a part NP1 of the connection piece 43A (also referred to as a “protruding part”) hits the main part 3 1A (to be exact, a hatching part TA1 in FIG. 3) of the anode side holding member 23A. Thus, after passing through the narrowed portion NA, the movement of the gripper 41A to the insertion direction is controlled by the connection piece 43A striking the main part 31A so that the gripper 41A is unable to move into the insertion direction. That is, the connection piece 43A protruded from the gripper 41A serves as means of control for controlling the movement of the gripper 41A into the insertion direction.

In the present first preferred embodiment, the anode side connection terminal 24A and the anode side holding member 23A are formed so that the part NP1 of the connection piece 43A hits the hatching part TA1 right after the gripper 41A passes through the narrowed portion NA.

As such, with a state in which the anode side connection terminal 24A is fitted into the anode side holding member 23A (see FIG. 4), the movement of the gripper 41A to the insertion direction and to the opposite direction as the insertion direction is controlled, allowing to place the gripper 41A in an electrode removable opening 36A without displacement.

Also, along the insertion of the gripper 41A into the hollow area 33A, the cylindrical terminal 42A is fitted into the opening 34A. Thereby, a connector 34CA for the cable assembly 26 is formed.

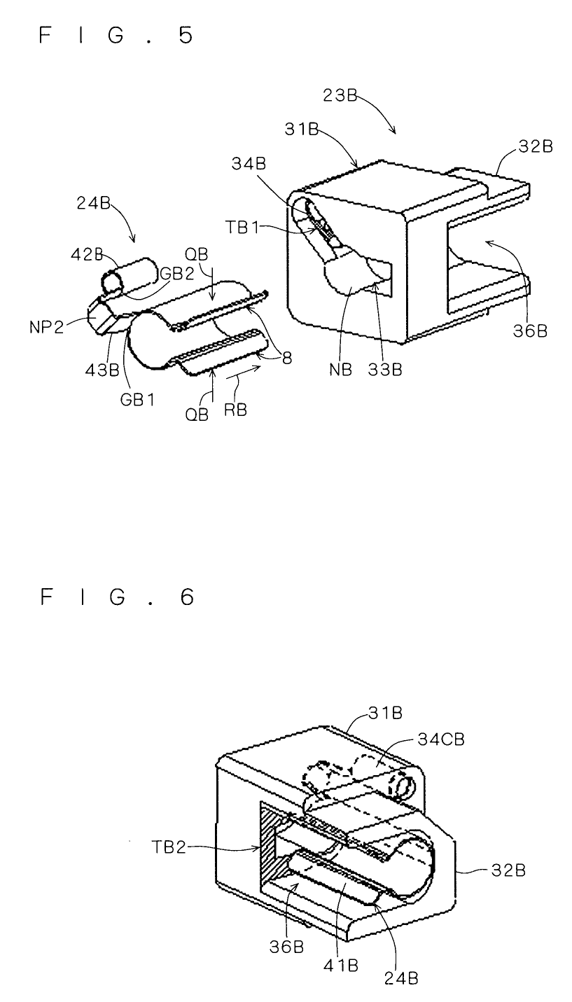

Next, a cathode side holding member 23B and a cathode side connection terminal 24B will be described below referring to FIGS. 5 and 6. FIG. 5 shows the cathode side holding member 23B and the cathode side connection terminal 24B. FIG. 6 is a view for showing the cathode side connection terminal 24B fitted in the cathode side holding member 23B. The cathode side holding member 23B has the same structure as the anode side holding member 23A except not having a structure (e.g., the concave portion UB1) for mounting the connector 35CA and the cable assembly 26.

More specifically, as shown in FIG. 5, the cathode side holding member 23B includes a substantially cubical main part 31B and a connection part 32B fitted into the housing case 22.

A hollow area 33B penetrating from one main surface to the other main surface (an facing surface) facing the main surface is formed in the main part 31B of the cathode side holding member 23B. The hollow area 33B includes a region (also referred to as a “narrowed portion”) NB of which opening size is narrower in the main surface side than the facing surface side. Further, a part of the cathode side connection terminal 24B (to be exact, a gripper 41B) is inserted into the hollow area 33B (described later).

Furthermore, an opening 34B is formed in the above-described main surface of the main part 31B. A through hole penetrating to the facing surface side is formed in the opening 34B, and a part of the cathode side connection terminal 24B (to be exact, a cylindrical terminal 42B) is inserted to the through hole.

Meanwhile, the connection part 32B leading to the housing case 22 is provided at the above-described facing surface side of the main part 31B. The connection part 32B is formed along a shape of cross section of a casing of the housing case 22 to be fitted into one end of the casing. An opening (also referred to as an “electrode removable opening”) 36B for attaching and removing electrodes linked to the hollow area 33B is formed in a surface of the connection part 32B corresponding to an opening side of the casing.

The cathode side connection terminal 24B includes a substantially tubular gripper 41B (41) formed by curving a plate member to form a substantially C-shaped cross section, a cylindrical terminal (also referred to as a “tube terminal”) 42B having a slit, and a connection piece 43B. The gripper 41B and the tube terminal 42B are electrically connected with each other through the connection piece 43B.

More specifically, the cathode side connection terminal 24B is configured by joining each edge portion of the substantially tubular gripper 41B and the tube terminal 42B with the connection piece 43B, the each edge portion being closest to each other in the edge portions defining each side surface of the tubular gripper 41B and the tube terminal 42B, with a state in which the tubular gripper 41B and the tube terminal 42B are placed to make their central axes substantially parallel to each other. Also, the gripper 41B, the connection piece 43B and the tube terminal 42B may be integrally formed by a mold.

As shown in FIG. 5, the connection piece 43B is formed by being folded back at two points so that a lateral edge GB1 at one side of a rectangular plate member in a short side direction is facing a lateral edge GB2 at the other side of the rectangular plate member. Then, the lateral edge GB1 at one side is connected to an edge of the gripper 41B formed in a substantially C-shape, and the lateral edge GB2 at the other side is connected to an edge of the tube terminal 42B.

The cathode side connection terminal 24B configured as the above is fitted into the main part 31B from the main surface of the main part 31B.

When fitting the cathode side connection terminal 24B into the cathode side holding member 23B, an opening of the narrowed portion NB in the hollow area 33B is formed smaller than a cross section of the gripper 41B so that the gripper 41B is inserted to a direction (insertion direction) shown by an arrow RB with being pressed from a direction shown by an arrow QB.

After the gripper 41B passes through the narrowed potion NB, the gripper 41B elastically deformed returns to its initial form. Thereby, when the gripper 41B is going to move to the opposite direction as the insertion direction after passing through the narrowed portion NB, a side surface of the gripper 41B is going to hit (strike) a hatching part TB2 shown in FIG. 6. Therefore, the gripper 41B cannot pass through the narrowed portion NB once again due to interference between the gripper 41B returned to its initial form and the hatching part TB2.

When the gripper 41B further moves into the insertion direction, a protruding part NP2 of the connection piece 43B hits the main part 31B (to be exact, a hatching part TB1 in FIG. 5) of the cathode side holding member 23B. Thus, after passing through the narrowed portion NB, the movement of the gripper 41B to the insertion direction is controlled by the connection piece 43B so that the gripper 41B is unable to move into the insertion direction. That is, the connection piece 43B protruded from the gripper 41B serves as means of control for controlling the movement of the gripper 41B into the insertion direction.

As such, with a state in which the cathode side connection terminal 24B is fitted into the cathode side holding member 23B (see FIG. 6), the movement of the gripper 41B to the insertion direction and to the opposite direction as the insertion direction is controlled, allowing to place the gripper 41B in the electrode removable opening 36B without displacement.

Also, along the insertion of the gripper 41B into the hollow area 33B, the cylindrical terminal 42B is fitted into the opening 34B. Thereby, a connector 34CB for the connection cable 25 is formed.

<Cable Assembly>

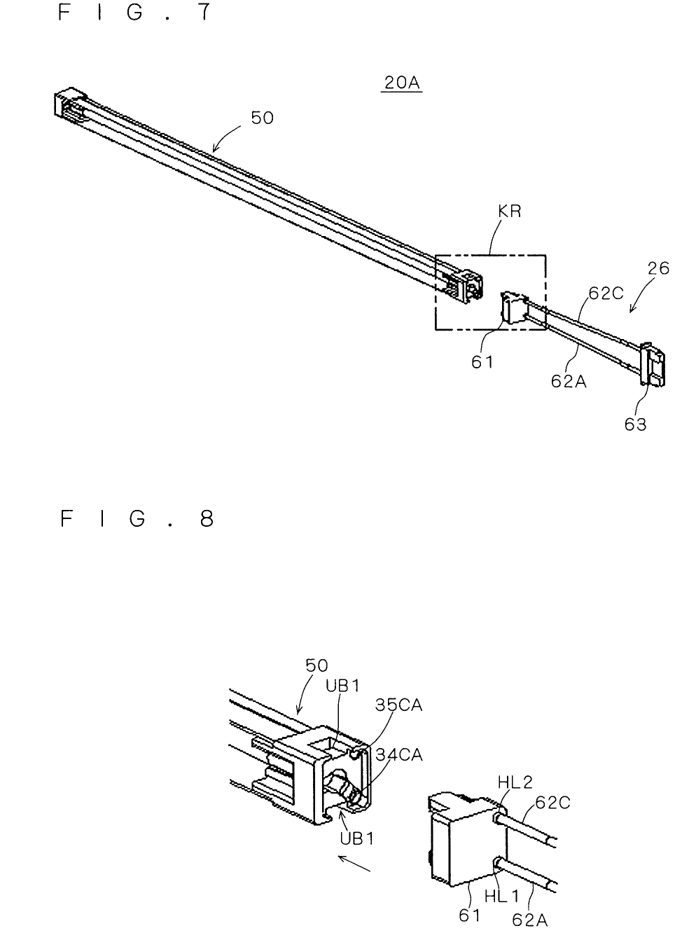

Next, details of the cable assembly 26 will be described. FIG. 7 is a view for showing a main body of the lamp unit 50 and the cable assembly 26. FIG. 8 is an enlarged view of an area surrounded by the broken line in FIG. 7. FIG. 9 is an enlarged view of an area surrounded by the broken line in FIG. 7 taken from the left.

As shown in FIG. 7, the cable assembly 26 includes a lamp side connector 61, an anode side lamp cable 62A, a cathode side lamp cable 62C and an external connector 63.

The lamp side connector 61 is formed of insulating material such as nylon-related resin or the like. Connection fixed nails MT, an anode side joint terminal SA, and a cathode side joint terminal SC are provided at an attachment side to the main body of the lamp unit 50 in the lamp side connector 61 (see FIG. 9). As shown in FIGS. 8 and 9, in attachment, the connection fixed nails MT, the anode side joint terminal SA and the cathode side joint terminal SC are fitted in the concave portions UB1, the connector 34CA and the connector 35CA which are provided at a side of main body of the lamp unit 50, respectively.

Further, the lamp side connector 61 includes connection holes HL1 and HL2 for inserting each joint terminal of the anode side lamp cable 62A and the cathode side lamp cable 62C.

The anode side lamp cable 62A includes crimp terminals at both ends for electrically connecting the external connector 63 to the connection hole HL1 provided in the lamp side connector 61. The cathode side lamp cable 62C includes crimp terminals at both ends for electrically connecting the external connector 63 to the connection hole HL2 provided in the lamp side connector 61.

The external connector 63 is a commercially available connector, and thus modifiable in accordance with devices or the like to be connected.

As described above, each component of the cable assembly 26 has a connector structure so that the cable assembly 26 has a structure with easy assembly and disassembly.

<Assembly Method>

Next, assembly method of the lamp unit 20A will be described. The lamp unit 20A having the above-described structure can be assembled by the following method, for example (see FIG. 2).

First, the anode side connection terminal 24A is fitted into the anode side holding member 23A, and at the same time, the cathode side connection terminal 24B is fitted into the cathode side holding member 23B.

Then, the anode side holding member 23A and the cathode side holding member 23B are attached to both ends of the housing case 22, respectively. It is noted that projection portions (not shown) for allowing the holding members 23A and 23B fixed to predetermined positions when they are fitted in the housing case 22 are provided in the connection parts 32A and 32B of the holding members 23A and 23B. On the other hand, the housing case 22 is provided with holes (not shown) for putting in the projection portions.

Next, joint terminals of the connection cable 25 are inserted into the connector 35CA of the anode side holding member 23A and the connector 34CB of the cathode side holding member 23B, respectively.

Subsequently, the preassembled cable assembly 26 is attached to the anode side holding member 23A.

Finally, the linear illuminant 21 is inserted from a lengthy opening side of the housing case 22, and then the external electrodes 212 of the linear illuminant 21 are fitted into the gripper 41A of the anode side connection terminal 24A and the gripper 41B of the cathode side connection terminal 24B, respectively. The linear illuminant 21 after being fitted in is held by elastic force of the grippers 41A and 41B, and at the same time the electrodes of the linear illuminant 21 are electrically connected to the grippers 41A and 41B.

It is possible to assemble the lamp unit 20A according to the above-described method, however, the assembly method can be voluntarily changed in accordance with working efficiency and the like.

As described in the above, in the lamp unit 20A mounted by inserting and extracting according to the present first preferred embodiment, the holding members 23 are fitted at both ends of the housing case 22 for housing the linear illuminant 21, and at the same time the connection terminals 24 are locked to the holding members 23. Each of the connection terminals 24 includes the gripper 41 for gripping the external electrodes 212 of the linear illuminant 21, and each of the external electrodes 212 is electrically connected to each of the connection terminals 24A and 24B by being gripped with each of the grippers 41.

Since the external electrodes of the linear illuminant 21 are electrically connected to the connection terminals 24 by being gripped with each of the grippers 41 of the connection terminals 24 in the lamp unit 20A having the above-described structure, connection by soldering is unnecessary, thereby allowing easy replacement of a lamp. Furthermore, since the connection by soldering is unnecessary, the risk of disconnection which may occur at connection parts by soldering can be eliminated, in addition to reducing a step of soldering.

Also, it is possible to lower heating value in emitting light by adopting an external electrode fluorescent lamp having external electrodes as the linear illuminant 21, thereby allowing extension of life of a lamp and improvement of display quality and the like. More in detail, if adopting a cold cathode fluorescent lamp (CCFL) which emits light by electrifying inside a glass tube, for example, heating value in emitting light would become large, causing shortened life of a lamp and loss of display quality and the like unless implementing a measure for heat dissipation. On the other hand, an external electrode fluorescent lamp which produces hardly any heat in emitting light (heating value is small) is adopted as the linear illuminant 21 in the present first preferred embodiment, thereby preventing shortened life of a lamp and loss of display quality.

Furthermore, as shown in FIG. 2, the lamp unit 20A has a structure with easy assembly and disassembly, allowing specifications to be easily modified, or the like.

### Second Preferred Embodiment

Next, the second preferred embodiment of the invention is described. A housing case and holding members are integrally formed in a lamp unit 20B according to the present second preferred embodiment, using insulating material with high reflection efficiency as material for the housing case. FIG. 10 is an exploded perspective view of the lamp unit 20B according to the second preferred embodiment.

The configuration and the operation of the lamp unit 20B according to the second preferred embodiment are almost identical to those of the lamp unit 20A described in the first preferred embodiment, and thus the same reference characters are applied to the common parts which are not described here.

Specifically, since heating value in emitting light of an external electrode fluorescent lamp adopted as a linear illuminant 21 is small in amount, insulating material with high reflection efficiency (white-related color nylon resin and the like) adopted for the holding members of the above first preferred embodiment is used as material for the housing case.

As shown in FIG. 10, the lamp unit 20B is configured using a reflector folder 70 in which the housing case and the holding members are integrally formed by injection molding. Thereby, assembly step of the lamp unit 20B can be further simplified.

While the invention has been shown and described in detail, the foregoing description is in all aspects illustrative and not restrictive. It is therefore understood that numerous modifications and variations can be devised without departing from the scope of the invention.

What is claimed is:

1. A lamp unit comprising:
a linear illuminant having external electrodes at both ends;
a housing case for housing said linear illuminant;
a pair of holding members fitted in both ends of said housing case; and
conductive connection terminals locked to each of said pair of holding members, respectively, wherein
each of said connection terminals includes a gripper for gripping each of said external electrodes of said linear illuminant, and
each of said external electrodes of said linear illuminant is electrically connected to each of said connection terminals by being gripped with each said gripper.

2. The lamp unit according to claim 1, wherein
said gripper is formed in a manner which a plate member is curved to form a substantially C-shaped cross section, and
each said gripper grips each of said external electrodes of said linear illuminant with elastic force.

3. The lamp unit according to claim 1, wherein
each of said pair of holding members includes a hollow area penetrating toward an extended direction of said linear illuminant,
each of said connection terminals includes a protruding part protruding from said gripper, and
said protruding part controls said gripper which is inserted to said hollow area to move into a direction in which said gripper is inserted.

4. The lamp unit according to claim 2, wherein
each of said pair of holding members includes a hollow area penetrating toward an extended direction of said linear illuminant,
each of said connection terminals includes a protruding portion protruding from the said gripper, and
said protruding part controls said gripper which is inserted to said hollow area to move into a direction in which said gripper is inserted.

5. The lamp unit according to claim 3, wherein
said hollow area includes a narrowed portion formed narrowly in an edge of inserting side, and
said gripper which is inserted to said hollow area with a state of being pressed in order to pass through said narrowed portion returns to an initial form after passing through said narrowed portion.

6. The lamp unit according to claim 4, wherein
said hollow area includes a narrowed portion formed narrowly in an edge of inserting side, and
said gripper which is inserted to said hollow area with a state of being pressed in order to pass through said narrowed portion returns to an initial form after passing through said narrowed portion.

7. The lamp unit according to claim 1, wherein
one holding member of said pair of holding members includes a connector to connect a cable for supplying power.

8. The lamp unit according to claim 1, wherein
said linear illuminant is an external electrode fluorescent lamp.

9. A lamp unit comprising:
a linear illuminant having external electrodes at both ends;
a housing case for housing said linear illuminant;
holding members for holding said linear illuminant in said housing case; and
conductive connection terminals locked to each of said holding members, wherein
said housing case and said holding members are integrally formed,
each of said connection terminals includes a gripper for gripping each of said external electrodes of said linear illuminant, and
each of said external electrodes of said linear illuminant is electrically connected to each of said connection terminals by being gripped with each said gripper.

10. The lamp unit according to claim 9, wherein
said linear illuminant is an external electrode fluorescent lamp.

11. An edge back light module comprising:
a lamp unit mounted on said edge back light module, wherein said lamp unit including:
a linear illuminant having external electrodes at both ends;
a housing case for housing said linear illuminant;
a pair of holding members fitted in both ends of said housing case; and
conductive connection terminals locked to each of said pair of holding members, respectively, wherein
each of said connection terminals includes a gripper for gripping each of said external electrodes of said linear illuminant, and
each of said external electrodes of said linear illuminant is electrically connected to each of said connection terminals by being gripped with each said gripper.

12. An edge back light module comprising:
a lamp unit mounted on said edge back light module, wherein said lamp unit including:
a linear illuminant having external electrodes at both ends;
a housing case for housing said linear illuminant;
holding members for holding said linear illuminant in said housing case; and
conductive connection terminals locked to each of said holding members, wherein
said housing case and said holding member are integrally formed,
each of said connection terminals includes a gripper for gripping each of said external electrodes of said linear illuminant, and
each of said external electrodes of said linear illuminant is electrically connected to each of said connection terminals by being gripped with each said gripper.

13. A liquid crystal display device comprising:
an edge back light module with a lamp unit mountable thereon, wherein said lamp unit including:
a linear illuminant having external electrodes at both ends;
a housing case for housing said linear illuminant;
a pair of holding members fitted in both ends of said housing case; and
conductive connection terminals locked to each of said pair of holding members, respectively, wherein
each of said connection terminals includes a gripper for gripping each of said external electrodes of said linear illuminant, and
each of said external electrodes of said linear illuminant is electrically connected to each of said connection terminals by being gripped with each said gripper.

14. A liquid crystal display device comprising:
an edge back light module with a lamp unit mountable thereon, wherein said lamp unit including:
a linear illuminant having external electrodes at both ends;
a housing case for housing said linear illuminant;
holding members for holding said linear illuminant in said housing case; and
conductive connection terminals locked to each of said holding members, wherein
said housing case and said holding member are integrally formed,
each of said connection terminals includes a gripper for gripping each of said external electrodes of said linear illuminant, and
each of said external electrodes of said linear illuminant is electrically connected to each of said connection terminals by being gripped with each said gripper.
